(19) United States
(12) Patent Application Publication
(10) Pub. No.: US 2003/0141739 A1
(43) Pub. Date: Jul. 31, 2003

(54) Sunshade apparatus for automobile

(76) Inventors: Dahai Dong, Cerritos, CA (US); Eugene Yuejin Chang, Cerritos, CA (US)

Correspondence Address: DAHAI DONG, 13329 Bigelow St., Cerritos, CA, 90703, US

(21) Appl. No.: 10/055,700

(22) Filed: Jan. 25, 2002

(51) Int. Cl. B60J 11/00

(52) U.S. Cl. 296/99.1

(57) ABSTRACT

The present invention provides sunshade apparatuses for automobile. An awning (12) is mounted above roof carry bars (10) of a vehicle. Within seconds of manual operation, the awing can either be retracted to occupy a small area typically 0.7×8 feet or be fully extended to generate a large rectangular shade area typically 7×8 feet above the automobile roof. If front part of the awning is made of a semi-transparent material for safe driving consideration of not blocking traffic lights, the awning may be manually retracted or extended by a driver within seconds even when the driver is driving. The sunshade apparatuses comprise multi-parallelogram shaped supporters (16). These supporters are extendable and retractable along the direction of vehicle width. Awning ribs (14) or awning rollers are perpendicularly mounted on the multi-parallelogram shaped supporters. The awning is mounted on the awning ribs or awning rollers, so that the awning becomes extendable and retractable along the direction of vehicle width. When the sunshade apparatus is in a retracted status, it also has the functions of roof carry bars to carry such as bicycles and surfboards.

### BACKGROUND OF THE INVENTION

1. Field of Invention

The present invention relates to protective shade apparatus for automobile, especially to retractable sunshade apparatus mounted on an automobile roof

2. Description of the Prior Art

Drivers and passengers may suffer extremely uncomfortable high temperature when they are entering parked automobiles exposed to sunlight in summer. To solve this problem, various sunshades have been proposed to shield parked automobiles from sunlight. These disclosed sunshades usually suffer drawbacks such as small shade area, inconvenience to use, or too expensive to commercialize. The Hellman U.S. Pat. No. 5,292,167 discloses a cover for vehicle windshield, but this cover has the drawback that the roof and the side windows are still exposed to sunlight. The Haung U.S. Pat. No. 5,230,545 discloses an awning roller assembly for parked cars which consists four awnings, a pair of awnings can cover the front and rear windows respectively, the third awning covers the roof, the forth awning extendible by two retractable rods controlled by an electric motor system is mainly designed to provide a temporary rain awning above one side of the car to protect passengers from getting wetted when they open or close their umbrella before getting on or off the car in rainy days. The drawbacks of this design are obviously due to the complicated mechanic structure, high cost, and poor shielding effect as a sunshade. The Kim U.S. Pat. No. 5,004,290 discloses a sunshade mounted on top of a car. It comprises a pair of side panels and a pair of longitudinal panels. Although the shade area can be increased via stretching the four panels, the mechanic structure of the apparatus is very complicated, the extension and retraction of the panels must be controlled and operated by a complicated motor-clutch-gear transmission. If a driver needs to manually generate or remove a large sunshade which may shade all of the windows of the vehicle even when the driver is driving, no such a kind of sunshade apparatus has ever been reported.

### SUMMARY OF THE INVENTION

If a driver is going to manually generate or retract a large rectangular awning which may shied all of the automobile windows from sunlight when the automobile is parked or is even at a fast driving speed, the invented sunshade apparatus enables the driver to realize this operation in seconds. The invented sunshade apparatus with several optional structures comprises all of or part of the following parts: A retractable awning, awning ribs or awning rollers for holding the awning, two multi-parallelogram shaped supporters for holding the awning ribs and/or awning rollers, two sliding guilders for the sliding of the multi-parallelogram shaped supporters, springs for automatically extending the awning, and a switch string which functions as a switch to extend or retract the awning. By using one hand to release or pull the switch string, a driver may manually extend or retract the awning in several seconds even when the driver is driving. An additional advantage of our invention is that it also has the similar functions of commercially available automobile roof carry bars when the apparatus is in a retracted status.

### BRIEF DESCRIPTION OF THE DRAWINGS

FIGS. 1-A and 1-B show perspective views of our disclosed sunshade apparatus mounted on the roof of a car when its awning is extended and retracted, respectively.

FIG. 2 shows a perspective view of a preferred embodiment of a proposed sunshade showing awning ribs, multi-parallelogram shaped supporters, springs, central and sliding bars, sliding guilders, base supporters, a string hole, a switch string, an O-ring on the string, an O-ring hook, and automobile roof carry bars.

FIG. 3 shows a perspective view of a preferred embodiment of a proposed sunshade similar to that shown in FIG. 2, but awnings are replaced by awning rollers.

FIG. 4 shows a perspective view of a preferred embodiment of a proposed sunshade similar to that shown in FIG. 3, but awning ribs are not used.

FIG. 5 shows a perspective view of a preferred embodiment of a proposed sunshade similar to that shown in FIG. 2, but awnings are replaced by central double layer awning rollers.

FIG. 6 shows a perspective view of a preferred embodiment of a proposed sunshade similar to that shown in FIG. 5, but only two awning ribs at most left and right sides are used.

FIG. 7 shows a perspective view of a preferred embodiment of a proposed sunshade showing two layers of awning ribs, awning, multi-parallelogram shaped supporters, central and sliding bars, sliding guilders, base supporters, a string hole, a switch string, an O-ring on the string, an O-ring hook, and automobile roof carry bars.

FIG. 8 shows an isometric view of an optional rigid arm with 3 joint positions and rectangular shape viewing from an end.

FIG. 9 shows a perspective view of an optional connection between a multi-parallelogram shaped supporter and a sliding guilder.

### DRAW REFERENCE NUMBER

10 automobile roof carry bar

12 awning

14 awning rib

16 multi-parallelogram shaped supporter

18 springs or rubber bands

20 sliding bar

22 rigid arm

24 joint position

26 short tube

28 socket

30 lock pin

32 short rod

34 central bar

36 sliding guilder

38 bar socket

40 non-sliding joint position

42 base supporter

44 string hole

46 switch string

48 O-ring hook

50 O-ring

52 front awning roller

54 middle awning roller

56 rear awning roller

58 left rigid arm

60 right rigid arm

62 central double layer awning roller

64 optional rigid arm

66 washer

### DETAILED DESCRIPTION OF PREFERRED EMBODIMENT

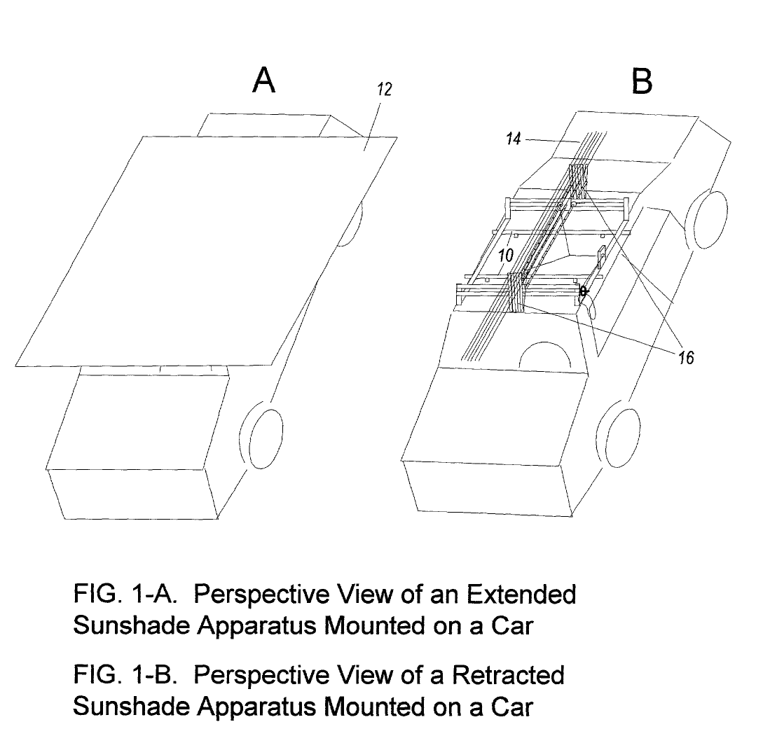

FIG. 1-A shows a perspective view of one of our proposed sunshade apparatuses mounted on automobile roof carry bars 10 when the sunshade apparatus's awning 12 is extended. The width of the extended awning 12 may be much wider than the automobile roof carry bars 10, so that all of the side windows of a car under the awning 12 can be shaded. The length of the awning 12 can be designed long enough to shade the front and rear sides of the car. FIG. 1-B shows a perspective view of the sunshade apparatus when the awning 12 is retracted, the width of the awning 12 is significantly reduced.

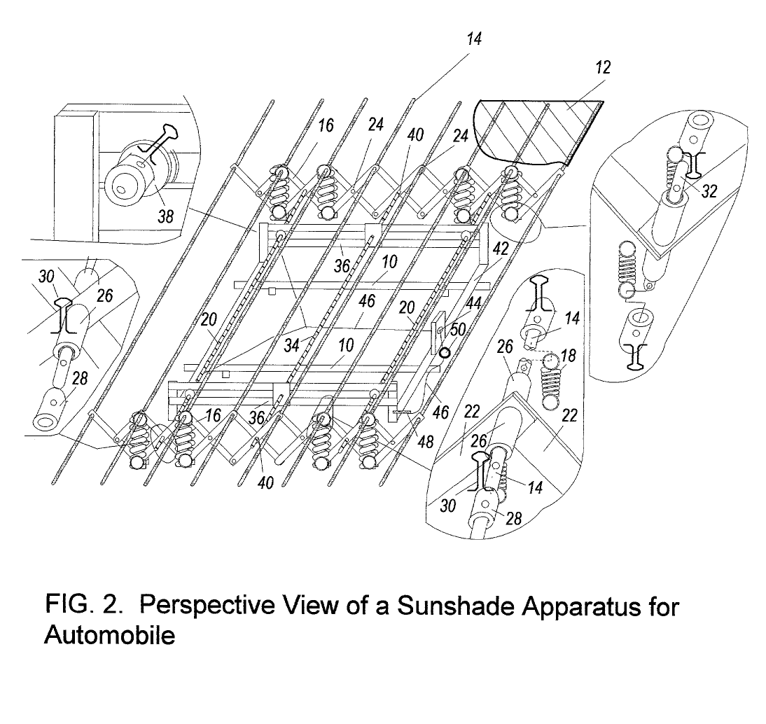

FIG. 2 shows a perspective view of a preferred embodiment of our invention. A flexible material or a rigid foldable material is used as an awning 12 that is permanently mounted to awning ribs 14. A transparent material may be used for the front part of the awning 12, so that the awning 12 will not block traffic signal lights when the awning 12 is extended and applied to a moving automobile. The awning ribs 14 are supported by two multi-parallelogram shaped supporters 16. Pairs of springs or rubber bands 18 are mounted to the multi-parallelogram shaped supporters 16. Using pairs of springs or rubber bands 18 is for applying balanced force. Retracting force of the springs or rubber bands 18 keep the multi-parallelogram shaped supporters 16 being extended if no opposite force is applied. It is not necessary to employ the springs or rubber bands 18 if the sunshade apparatus is designed only for a parked automobile or if a spring retraction force (not shown in FIG. 2) is applied to a sliding bar 20 or an awning rib 14. The multi-parallelogram shaped supporters 16 are made of many rigid arms 22. Most of rigid arms 22 have three joint positions 24; these rigid arms are connected each other through joint positions 24. The connection with free rotation at joint position 24 of the rigid arms 22 is a known art that can be applied to some of the joint positions 24. Special connection at joint positions 24 is illustrated as following two situations: Situation one, at each position where an awning rib 14 needs to pass through a joint position 24, a short tube 26 is permanently attached to the joint position 24 of the rigid arm 22. This attached short-tube design keeps the multi-parallelogram shaped supporters 16 being perpendicular to awning ribs 14; an amplified detail structure is shown in FIG. 2 where sockets 28 and lock pins 30 are used to make connection. Situation two, at each position of joint position 24 of rigid arms 22 where a pair of springs or rubber bands 18 must be connected and where it is at the opposite side of awning rib 14, a short rod 32, two short tubes 26, two sockets 28, and two lock pins 30 are used to make connection; an amplified detail structure is shown in FIG. 2. The multi-parallelogram shaped supporters 16 are supported by a central bar 34 and two sliding bars 20. At each connection position (16 with 20, or 16 with 34), a short tube 26 is permanently attached to the joint position 24 of the rigid arm 22. This attached short-tube design keeps the multi-parallelogram shaped supporters 16 being perpendicular to the central bar 34 and sliding bars 20; an amplified detail structure is shown in FIG. 2 where sockets 28 and lock pins 30 are used to make connection. The central bar 34 is fixed at center of two sliding guilders 36, and the two sliding bars 20 can slide along the sliding guilders 36. Two or four bar sockets 38 per bar (34 or 20) are used to fix the longitudinal position of the central 34 and sliding 20 bars relative to the sliding guilders 36. The multi-parallelogram shaped supporters 16 are in extended or retracted status depending on the position of sliding bars 20 at end or near center of the sliding guilders 36, respectively. Because the central bar 34 can not slide and passes through a non-sliding joint position 40 per multi-parallelogram shaped supporters 16, pushing one side of the multi-parallelogram shaped supporters 16 towards to the center should retract the other side of the multi-parallelogram shaped supporters 16 simultaneously, and vice versa. The sliding guilders 36 are mounted onto two base supporters 42 using screws and nuts. The base supports 42 are mounted on commercially available roof carry bars 10. This kind of perpendicular mounting technology is a known art. It should be mentioned that the sliding guilders 36 are non-moving parts of the sunshade apparatus and how to mount a non-moving part to the roof of a car is a known art. There are many other methods to mount non-moving objects such as the sliding guilders 36 on the roof of an automobile. As an example, a sliding guilder is directly attached to a roof carry bar to become one part, so that one piece of object may have the functions of not only sliding guilder but also roof carry bar. As another example, base supporters are directly attached to roof carry bars so that one piece of object may have the functions of not only base supporter but also roof carry bar. Both examples are not shown in FIG. 2. There is a string hole 44 on the center of one of the base supporters 42. A switch string 46 connecting to one of the sliding bars 20 passes through this string hole 44, so that a driver sitting at driver seat can pull or release this switch string 46 to retract or extend the awning 12. The other end of the switch string 46 may be attached to an O-ring hook 48 or to any position close to the O-ring hook 48. There is a rigid O-ring 50 on the switch string 46. The awning 12 can be kept retracted if a user inserts the O-ring 50 to the O-ring hook 48. The awning 12 can be kept at an extension status if the O-ring 50 is not inserted to the O-ring hook 48. The extension and retraction of the multi-parallelogram shaped supporters 16 may also be realized by an electric motor (not shown in FIG. 2) that can pull or release the switch string 46. In this case, the O-ring 50 and the O-ring hook 48 are not needed, and the electric motor can be mounted at the position of string hole 44.

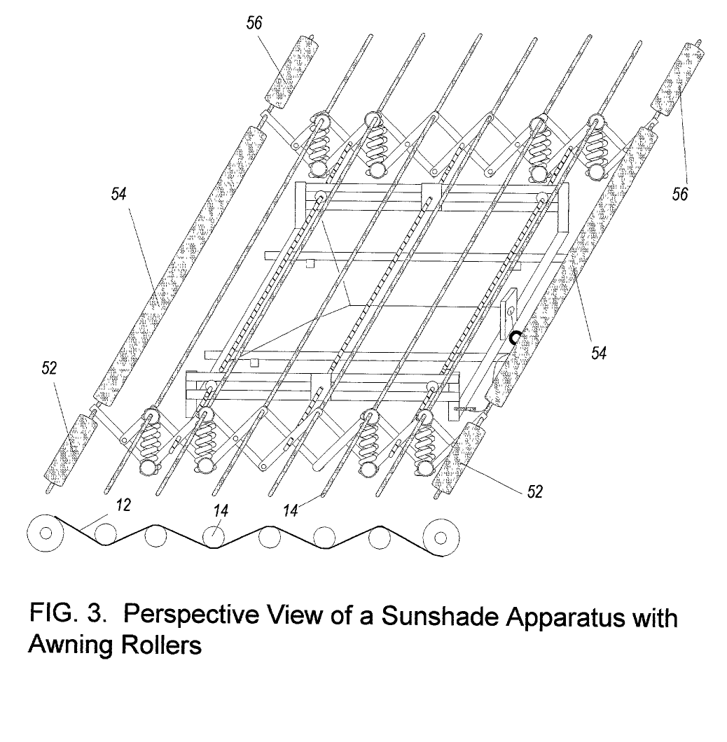

FIG. 3 shows a perspective view of another preferred embodiment of our invention. Most structures of the hardware are identical to that shown in FIG. 2. The major difference can be illustrated as follows: Two front awning rollers 52, two middle awning rollers 54, and two rear awning rollers 56 are mounted on the positions of most left and right positions of multi-parallelogram shaped supporters, respectively. A pair of awning rollers 52, 54, or 56 shares one piece of awning 12. The awning rollers 52, 54, and 56 have springs in them, so that a roller 52, 54, or 56 can automatically retract its awning 12 if an opposite force is not applied. This kind of retracting technology for awning roller is a known art. The awnings 12 are not permanently mounted to awning ribs 14; the awnings 12 can slide through the surface of the awning ribs 14. As a minor modification to the embodiment shown in FIG. 3, one of two front, middle, and rear awning rollers 52, 54, and 56 may be replaced by an awning rib (not shown in FIG. 3). This modified embodiment has similar operation function as that shown in FIG. 3

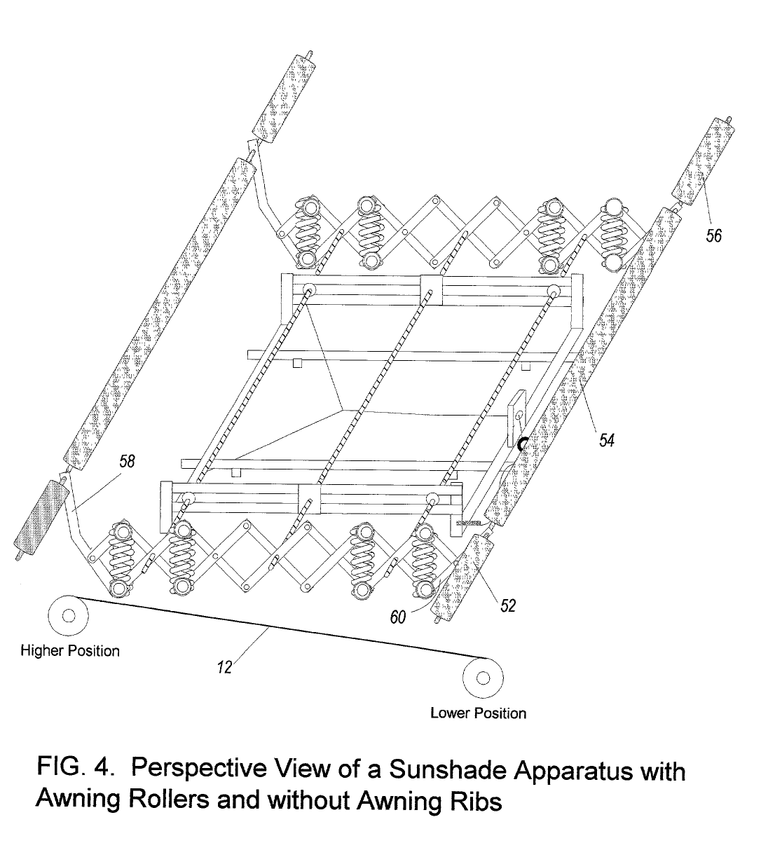

FIG. 4 shows a perspective view of another preferred embodiment of our invention. Most structures of the hardware are identical to that shown in FIG. 3. The major difference can be illustrated as follows: The awning ribs 14 shown in FIG. 3 are not used. The shape of left rigid arms 58 and right rigid arms 60 on multi-parallelogram shaped supporters 16 may be different each other and may be different to that of the other rigid arms 20, so that the two awning rollers 52,54, or 56 will be at top and bottom positions respectively or at bottom and top positions respectively to minimize the blocked view area when the awning 12 of the apparatus is in a retracted status. Other preferred embodiments of our invention can be based on a hybrid structure derived from FIGS. 3 and 4, only partial awning ribs 14 shown in FIG. 3 are employed in the hybrid structure.

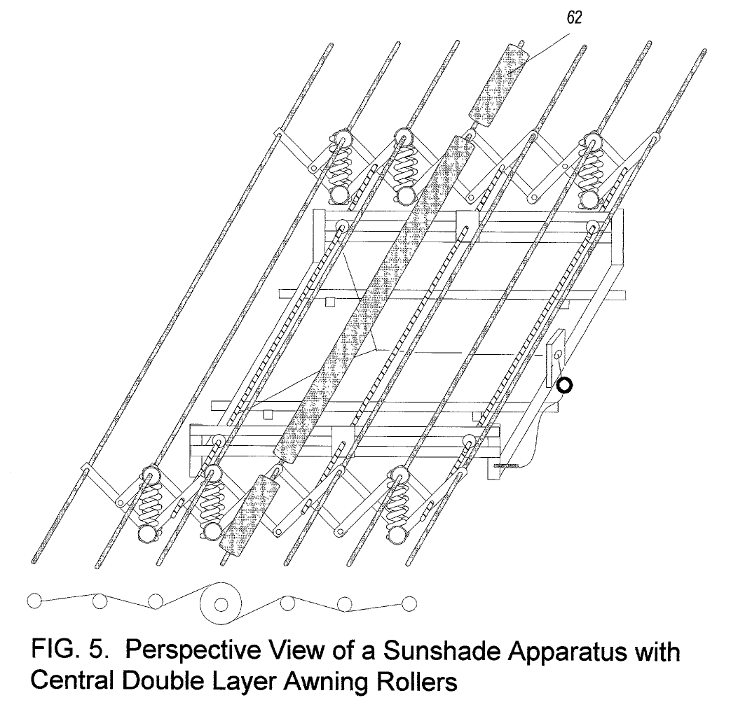

FIG. 5 shows a perspective view of another preferred embodiment of our invention. Most structures of the hardware are identical to that shown in FIG. 2. The major difference can be illustrated as follows: Central double layer awning rollers 62 are mounted on the positions of center of multi-parallelogram shaped supporters 16. The central double layer awning roller 62 has two layers of awnings to be surrounded on the roller. One layer of the awning 12 will be used to cover the left side and the other layer of the awning 12 will be used to cover the right side. The central double layer awning roller 62 has springs in them, so that it can automatically retract its awning 12 if an opposite force is not applied. This kind of retracting technology for awning roller is a known art. Expect the awning ribs 14 at the most left and right sides, the awnings 12 are not permanently mounted to awning ribs 14; the awnings 12 can slide through the surface of the awning ribs 14.

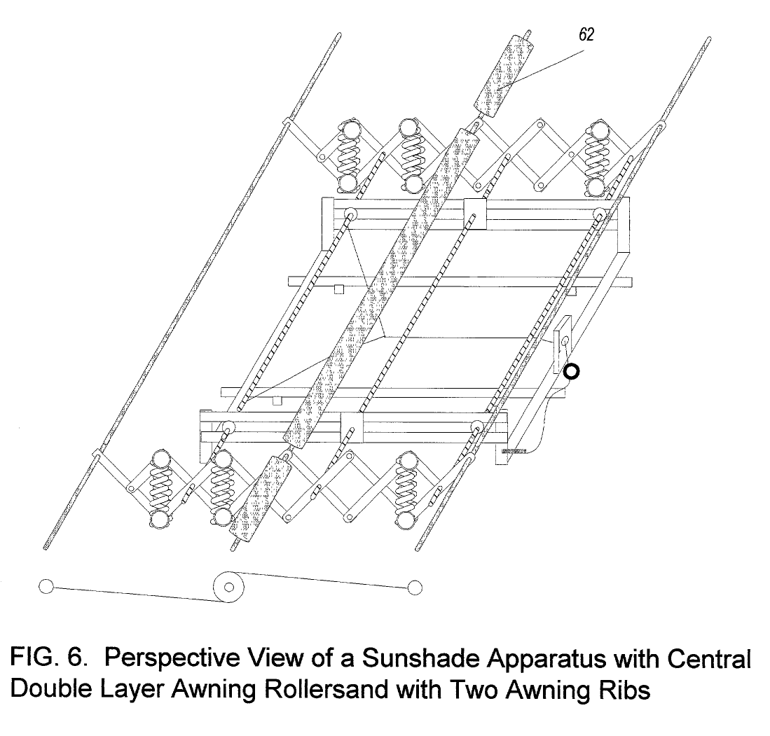

FIG. 6 shows a perspective view of another preferred embodiment of our invention. Most structures of the hardware are identical to that shown in FIG. 5. The major difference can be illustrated as follows: Expect the awning ribs 14 at the most left and right sides, the awning ribs 14 shown in FIG. 5 are not used. Other preferred embodiments of our invention can be based on a hybrid structure derived from FIGS. 5 and 6, only partial awning ribs 14 shown in FIG. 5 are employed in the hybrid structure.

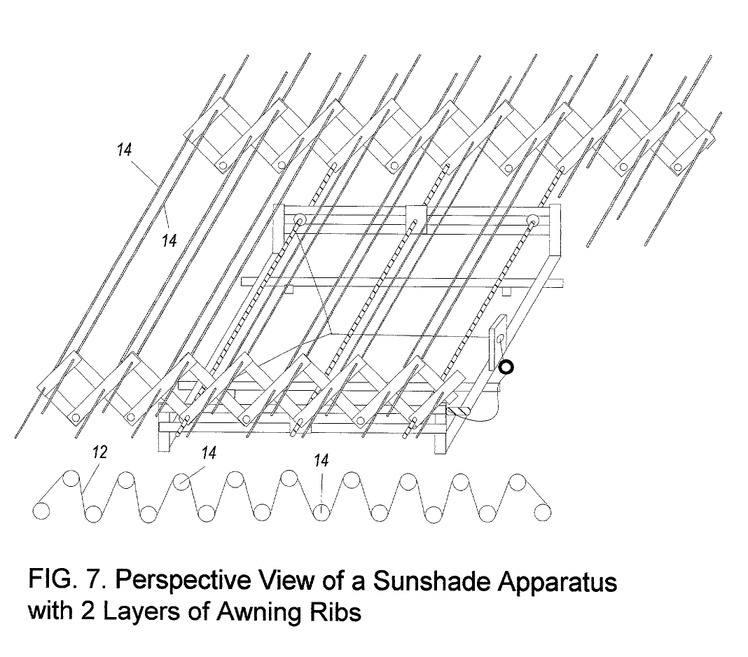

FIG. 7 shows a perspective view of another preferred embodiment of our invention. Most structures of the hardware are identical to that shown in FIG. 2. The major difference can be illustrated as follows: There are two layers instead of one layer of awning ribs 14. Front, middle, and rear awnings 12 are mounted onto two layers of awning ribs 14 in a zigzag pattern.

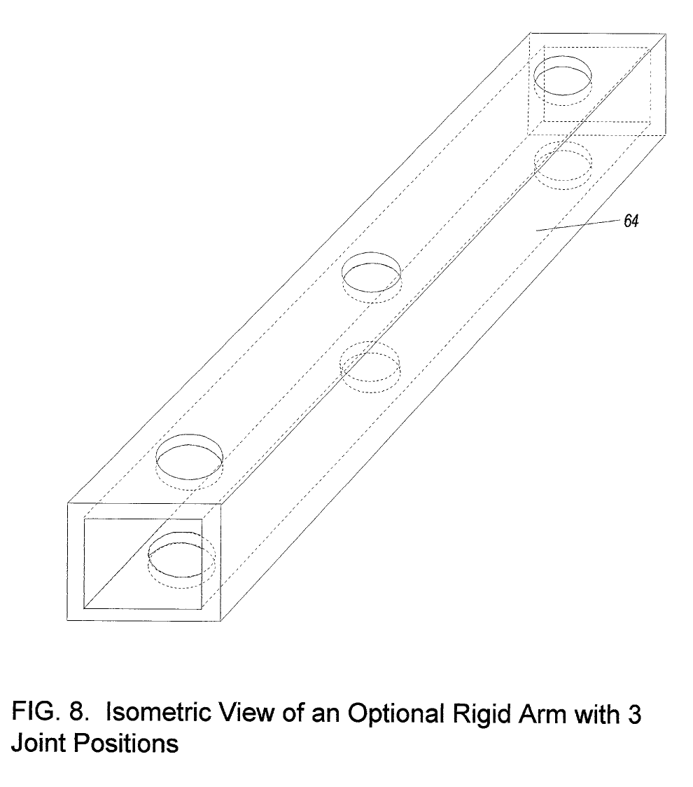

FIG. 8 shows an isometric view of an optional rigid arm 64 with 3 joint positions and rectangular shape viewing from an end. The optional rigid arm 64 should provide same function as a rigid arm 22 with short tubes 26 because the optional rigid arm 62 can be made thick enough in both dimensions to keep the optional rigid arm 62 being perpendicular to awning ribs 14 or awning rollers 52, 54, and 56.

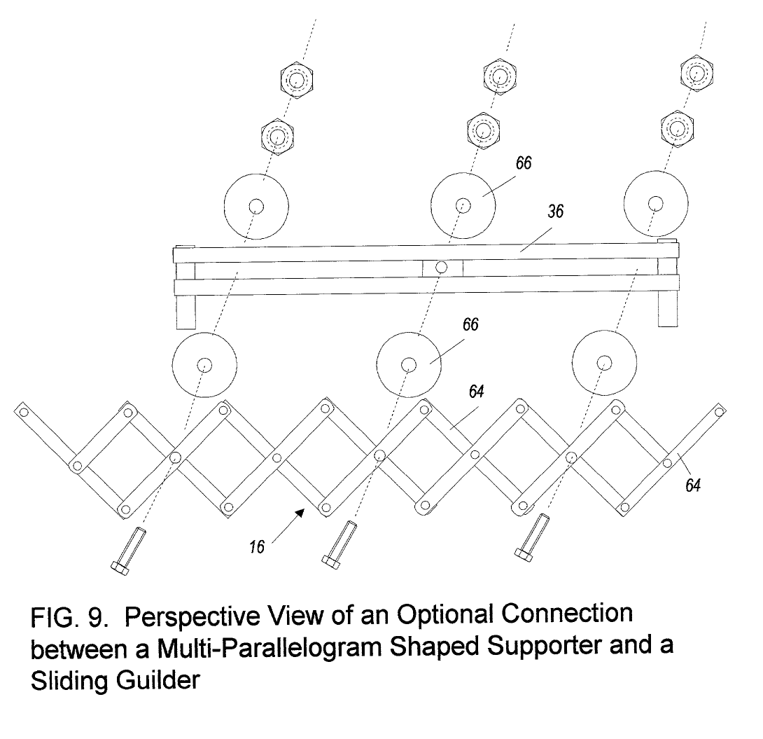

FIG. 9 shows a perspective view of an optional connection between a multi-parallelogram shaped supporter 16 and a sliding guilder 36. Washers 64 are inserted between the multi-parallelogram shaped supporter 16 and the sliding guilder 36. The rigid arms 64 at the two ends will not be blocked by sliding guilder 36 during the retraction because there is a distance of a washer's thickness between the multi-parallelogram shaped supporter 16 and the sliding guilder 36. The connection is realized by bolts, washers, and nuts. The non-sliding joint position 40 of the multi-parallelogram shaped supporter 16 is horizontally fixed so that this joint position 40 cannot slide along the sliding guilder.

Another preferred embodiment of connection between a multi-parallelogram shaped supporter and a sliding guilder can be described as a hydride of embodiments shown in FIGS. 2 and 7. In this preferred embodiment, the central bar 34 and sliding bars 20 are shared by two multi-parallelogram shaped supporters 16 as shown in FIG. 2, but the distance between the multi-parallelogram shaped supporter 16 and the sliding guilder 38 is the thickness of a washer 66 as shown in FIG. 7. Both ends of the central bar 34 and sliding bars 36 can be similar to that of a bolt so that nuts can be used on the ends to complete the connection.

We claim:

1. A multi-parallelogram shaped supporter for the supporting of retractable awning mounted on an automobile's roof comprising:
(a) rigid arms, each said rigid arm has at least three joint positions if said rigid arm is not at either ends of said multi-parallelogram shaped supporter, said rigid arms are connected each other through said joint positions, each said rigid arm can be rotated around its said joint positions, and
(b) only one non-sliding joint position that does not slide while other said joint positions are in moving when said retractable awning is during extension or retraction.

2. The multi-parallelogram shaped supporter of claim 1 further comprising springs or rubber bands.

3. A sunshade apparatus mountable on an automobile's roof comprising:
(a) an awning with awning ribs, or an awning roller,
(b) multi-parallelogram shaped supporters, the characteristic of said multi-parallelogram shaped supporter shows several parallelogram shaped segments, each said parallelogram shaped segment is formed by connecting four rigid arms at 4 joint positions, and
(c) sliding guilders that are able to be mounted on roof of an automobile and provide a sliding guidance for the extension and retraction of said multi-parallelogram shaped supporters; only one joint position of each said multi-parallelogram shaped supporter is horizontally fixed to a said sliding guilder and can not slide along said sliding guilder while other said joint positions of said multi-parallelogram shaped supporter are in moving when said awning is during extension or retraction moving.

4. The sunshade apparatus mountable on an automobile's roof of claim 3 further comprising:
(a) a central bar that does not slide along said sliding guilders, and
(b) sliding bars that can slid along said sliding guilders.

5. The sunshade apparatus mountable on an automobile's roof of claim 3 or claim 4 further comprising:
(a) springs or rubber bands that are mounted on said multi-parallelogram shaped supporters, and
(b) a switch string, pulling or releasing said switch string controls said multi-parallelogram shaped supporters at a retraction or extension status, this function may be realized manually by a user or automatically by an electric motor.

6. A pair of connected awning rollers to be used for automobile sunshade comprising:
(a) one piece of awning, and
(b) a pair of awning rollers that shares said one piece of awning and with springs in said awning rollers; the awning will be retracted automatically into the awning rollers if an opposite force is not applied.
